(19) United States
(12) Patent Application Publication
(10) Pub. No.: US 2020/0160276 A1
(43) Pub. Date: May 21, 2020

(54) SETTING, VISUALIZING AND PREDICTING AN AVAILABILITY STATUS OF AN INDIVIDUAL IN OPEN WORKING ENVIRONMENT

(71) Applicant: International Business Machines Corporation, Armonk, NY (US)

(72) Inventors: Theresa Hans, Poughkeepsie, NY (US); Christopher Robbins, Monroe Township, NJ (US)

(21) Appl. No.: 16/196,250

(22) Filed: Nov. 20, 2018

(51) Int. Cl. G06Q 10/10; H04L 29/08

(52) U.S. Cl. CPC G06Q 10/1093; H04L 67/22

(57) ABSTRACT

Methods, systems and computer program products for determining and providing an availability status of an individual in an open working environment are provided. Aspects include obtaining historical usage data, communication data, calendar data, and statuses set data from selected network-connected devices used by the individual, and calculating a current availability status for the individual based on the historical usage data, the communication data, calendar data, and the statuses set data. Aspects also include calculating a predicted future availability status for the individual based on the historical usage data, the communication data, calendar data, and the statuses set data, and visibly displaying proximate the individual's workspace the current availability status and the predicted future availability status to others in the open working environment.

### BACKGROUND

The present invention generally relates to an availability status of an individual in an open workspace or office, and more particularly to methods and systems for setting, visualizing and predicting an availability status of an individual in the open workspace or office.

In typical open workspaces or offices, an individual manually sets an availability status that is displayed to other users in the open working environment, which are used to convey the availability of the individual for possible interruption via a physical cue including, but not limited to, an availability card on the individual's desk, particular individual's social cues or working style (e.g., wearing headphones means “do not disturb”). In general, the physical cue, such as an availability card at the individual's workspace allows the individual to select his or her availability status from a small, discrete set of predefined availability status values such as “Available,” “Away,” “In a Meeting,” or the like.

In many cases, this limited set of availability status values does not always include an option that accurately represents the actual status of an individual. In addition, the availability statuses of individuals are often inaccurate due to the requirement that the availability status be updated manually and because many individuals do not update their availability status throughout the day as their availability changes.

While some computer applications do allow the automatic setting of a specific availability status based on events such as the amount of time that has passed since the last activity of an individual's keyboard, these settings need to be manually configured and updated by the individual and the available configuration options are relatively basic. In addition, the basic metrics may not provide an accurate representation of the individual's availability status.

### SUMMARY

In accordance with an embodiment, a method for determining and providing an availability status of an individual in an open working environment includes obtaining historical usage data for the individual in the open working environment. The method also includes obtaining communication data, calendar data and statuses set data for the individual from selected network-connected devices used by the individual. In exemplary embodiments, the data collected from the selected network-connected devices used by the individual includes number, type and activity level of open applications; communication activity; schedule information; and statuses set in applications among the selected network-connected devices. The method also includes calculating a current availability status of the individual based on the data collected from the selected network-connected devices used by the individual including the historical usage data, the communication data, the calendar data and the statuses set data and calculating a predicted future availability status for the individual based on the historical usage data, the communication data, the calendar data and the statuses set data. The method also includes visibly displaying on a physical network-connected device proximate a workspace of the individual the current availability status and the predicted future availability status to others in the open working environment.

In another embodiment of the invention, a processing system for determining and providing an availability status of an individual in an open working environment includes a processor configured to control a content displayed on a display screen. The processor is configured to obtain historical usage data for the individual from selected network-connected devices used by the individual in the open working environment and to obtain communication data, calendar data, and statuses set data for the individual from the selected network-connected devices. The processor is also configured to calculate a current availability status of the individual based on the historical usage data, the communication data, the calendar data and the statuses set data and to calculate a predicted future availability status for the individual based on the historical usage data, the communication data, the calendar data and the statuses set data. The processor is further configured to visibly display on a physical network-connected device proximate a workspace of the individual the current availability status and the predicted future availability status to others in the open working environment.

In accordance with a further embodiment, a computer program product for determining and providing an availability status of an individual in an open environment includes a non-transitory storage medium readable by a processing circuit and storing instructions for execution by the processing circuit for performing a method. The method includes obtaining historical usage data for the individual from selected network-connected devices used by the individual in the open working environment and obtaining communication data, calendar data and statuses set data for the individual from the selected network-connected devices. The method also includes calculating a current availability status of the individual based on the historical usage data, the communication data, the calendar data and the statuses set data and calculating a predicted future availability status for the individual based on the historical usage data, the communication data, the calendar data and the statuses set data. The method also includes visibly displaying on a physical network-connected device proximate a workspace of the individual the current availability status and the predicted future availability status to others in the open working environment.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram illustrating one example of a processing system for practice of the teachings herein;

FIG. 2 is a block diagram illustrating an open working environment system for practice of the teachings herein;

FIG. 3A is an illustration of graphical user interface for depiction on a physical visual device for providing an availability status of an individual in an open working environment in accordance with an embodiment;

FIG. 3B is an enlarged partial view of FIG. 2 illustrating another graphical user interface for depiction on a visible physical device for providing an availability status of an individual in an open working environment in accordance with an embodiment;

FIGS. 4A and 4B are block diagrams illustrating the visible physical device of FIG. 3B in FIG. 4A and then transitioning to a different availability status 5 minutes later in time in FIG. 4B in accordance with an embodiment;

FIG. 5 is a block diagram illustrating the visible physical device in FIG. 4B flashing in different colors during a brief sequential time period in accordance with an embodiment; and

FIG. 6 shows a flow chart illustrating a method for determining and providing an availability status of an individual in an open working environment in accordance with an embodiment.

### DETAILED DESCRIPTION

Embodiments include methods, systems, and computer program products for determining and providing physical visual representation of a continuous availability status of an individual in an open working environment. In exemplary embodiments, the continuous availability status of an individual is calculated and visibly displayed for others to see on a network-connected device that indicates the level of availability of the individual for possible interruption. The continuous availability status is calculated based on machine learning and data analytic techniques that take a wide variety of variables related to the individual into account. In exemplary embodiments, in addition to a current availability status being calculated and provided, a predicted future availability status of the individual is also calculated and provided. In exemplary embodiments, both the current availability status and the predicted future availability status of an individual are calculated and updated automatically based on the data collected from the individual's selected network-connected devices, including, but not limited to, the individual's computer, tablet, smartphone, or smartwatch. The availability status and the predicted future availability status are visibly displayed proximate the individual's workspace to others in the open working environment via a physical network-connected device such that the availability of the individual for possible interruption or communication is readily apparent.

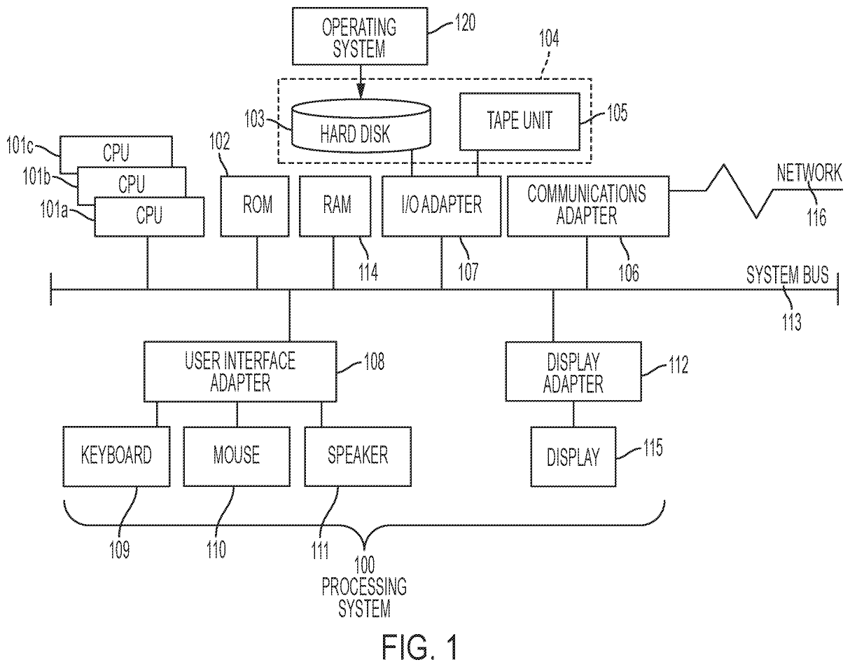

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the processing system 100 includes processing capability in the form of processors 101, storage capability including the system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

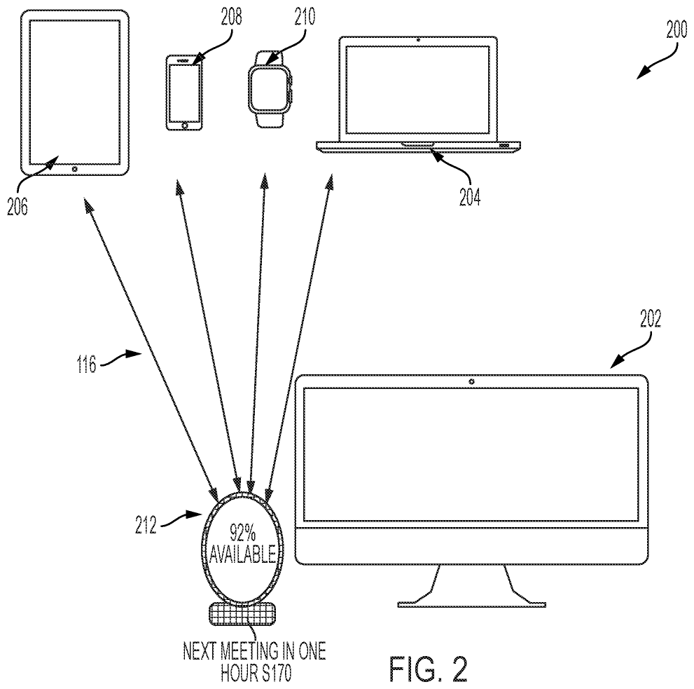

Referring now to FIG. 2, there is shown an open working environment system 200 for implementing the teachings herein. As illustrated, the system 200 includes a first user device 202, a second user device 204, a third user device 206, a fourth user device 208, a fifth user device 210 and a visible physical device 212. In exemplary embodiments, the first through fifth user devices 202-210 may be a processing system as shown in FIG. 1, a personal computer (202), laptop computer (204), a tablet computer (206), a smartphone (208), a smart watch (210), or another suitable device that is connected to the network 116 in FIG. 1. At least one if not all of the first through fifth user devices 202-210 are in communication with the visible physical device 212 proximate the workspace of an individual that uses the first through fifth user devices 202-210 (shown by double ended arrows in FIG. 2). Software running on the visible device 212 or one of the other network-connected user devices 202-210 facilitates the exchange of data collection and analysis between the first through fifth user devices 202-210 and the visible physical device 212. In exemplary embodiments, the first through fifth user devices 202-210 include an application that includes a graphical user interface (GUI) that is used to exchange data.

Although the open working environment system 200 in FIG. 2 is shown as an open workspace, the open working environment system 200 may be an individual's office at the workplace, home or elsewhere. For example, the open working environment system 200 may provide advantages in an office or home office to alert others of the availability of the individual with an “open door” policy to be able to discern if the individual may be interrupted or may be in a conference call meeting. That is, it may not be easily discerned if the individual is on the telephone in such a situation, especially if the individual is wearing a wireless transceiver headset in an opposite ear that the person who wants to interrupt cannot see.

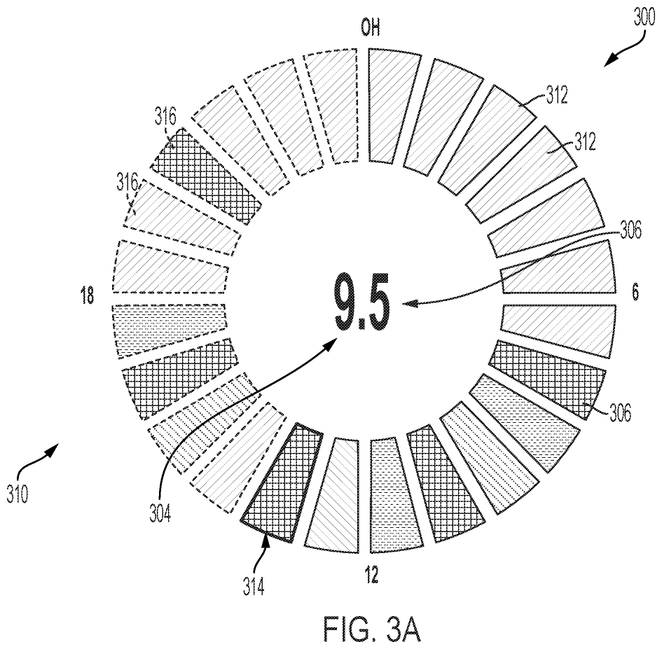

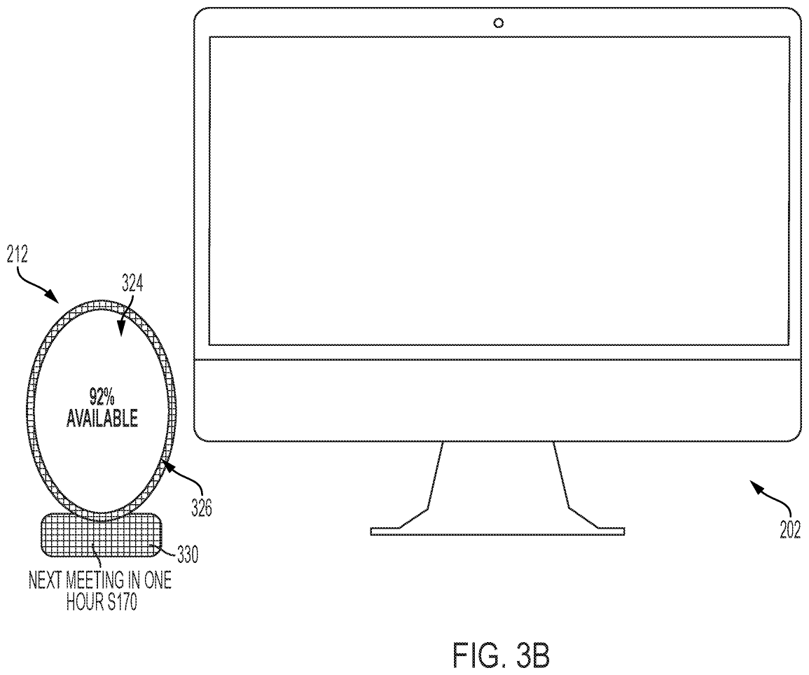

Referring now to FIGS. 3A and 3B, illustrations of the visible physical 212 in FIG. 2 for visualizing the availability statuses of an individual in a particular workspace in an open working environment in accordance with two exemplary embodiments are shown.

As shown in FIG. 3A, the visible physical device 212 of FIG. 2 may include an LCD/LED based solution that attaches to or is proximate a monitor of the first user device 202 or proximate one of the other user devices 204-210 and displays a colorized bar indicating business/availability. FIG. 2 shows the visible physical device 212 as a free-standing network-connected device. Generally, any visible physical device 212 that visibly displays a continuous availability scored based on activity collected from the network-connected devices 202-210 is contemplated. The visible physical device 212 may include a GUI 300 that indicates the current and future availability of an individual that resides in the workspace where the visible physical device 212 is located. The GUI 300 is shown with a current availability status score 304 indicated as “9.5” and an associated color indicator 306, i.e., “9.5” text in green color. In exemplary embodiments, the current availability status score 304 is a numerical value that is greater than or equal to a minimum number, for example zero, and less than or equal to a maximum number, for example ten. In one embodiment, the availability status score 304 includes only one decimal place. In exemplary embodiments, a pigment of the color indicator 306 is determined based on the numerical value of the current availability status score 304. In one embodiment, the GUI 300 may also include a legend (not shown) that provides a correlation between the pigment of the color indicator 306 and the availability of the individual. In one embodiment, an availability status score of zero corresponds to a red color indicator and an availability status score of zero corresponds to a green color indicator. In exemplary embodiments, a user may initiate an interruption or communication with an individual when the GUI 300 indicates the individual is available via the current availability status score 304 and/or the associated color indicator 306.

In exemplary embodiments, a user in the open working environment can use the GUI 300 to request a predicted future availability status of the individual in the workspace having the visible physical device 212. In exemplary embodiments, the user may view the predicted future availability for the individual by examining color indicators 306 associated with the individual past that indicated for the current time or by another suitable means.

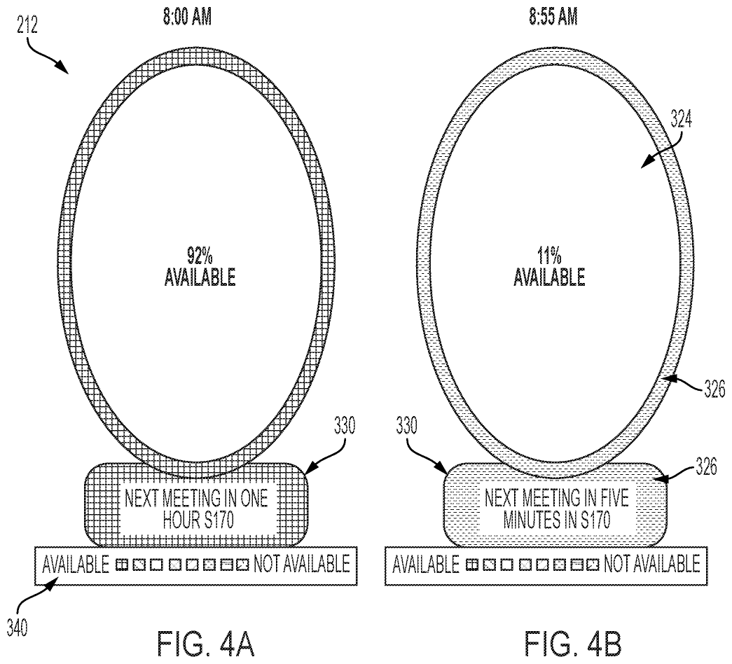

As best shown in FIG. 3A, the predicted future availability status 310 for the selected individual includes the current availability status score 304 displayed in a central portion of the predicted future availability status 310. In exemplary embodiments, the pigment of the current availability status score 304 is determined based on the numerical value of the current availability status score 304 according to the legend (see legend 340 in FIGS. 4A and 4B, for example). In exemplary embodiments, the predicted future availability status 310 includes a plurality of availability status indicators 312, 314, 316, which each represent an hour of the current day.

In exemplary embodiments, the plurality of availability status indicators 312, 314, 316 are arranged in a radial manner around the current availability status score 304. In exemplary embodiments, the pigment of the availability status indicators 312, 314, 316 are determined based on a numerical value of the availability status score that corresponds to the time period of the availability status indicators 312, 314, 316. However, use of any appropriate continuous color scale that is indicative of an individual's availability is contemplated, and not limited to that shown in FIG. 3A. In one embodiment, status indicators 312 refer to recent availability statuses of the selected contact and the status indicator 314 refers to the current availability status of the selected contact. In exemplary embodiments, the status indicator 314 is visually distinguishable from the status indicators 312 by a solid black line around the status indicator 314. In one embodiment, the status indicators 316 refer to predicted future availability status scores for each hour remaining in a current day for the selected contact. In exemplary embodiments, the status indicators 316 are visually distinguishable from the status indicators 314 by a dashed black line around the status indicators 316. In other embodiments, the messaging application can be configured to show the predicted future availability scores through the next week or month and beyond if needed. The predicted scores allow a user to select the best time to meet with or begin chatting with a contact, rather than having to decide based upon only current availability status information.

FIG. 3B is another exemplary embodiment of the visible device 212 located near the individual's first user device 202. The visible physical device 212 in FIG. 3B is similar to the one shown in FIG. 3A. The visible physical device 212 displays a numerical percentage for a current availability status score 324 indicated as “92%” and an associated color indicator 326, e.g., “92%” text in green color (not shown), as well as the outline of the visible physical device 212 being lit in the associated green color. The visible physical device 212 also provides added information to the individual and others in the open working environment by providing “how” available the individual is based on the individual's meetings, emails, current works, upcoming meetings and appointments, and other aggregated data. This additional information may be displayed on the visible physical device 212 at portion 330 for the individual and others in the working environment to view. For example, as illustrated in FIG. 3B, portion 330 indicates to both the individual and others in the working environment that the individual has a meeting in “one hour” in room “170”.

FIGS. 4A and 4B illustrate another exemplary embodiment of the visible physical device 212 shown in FIG. 3B. FIG. 4A is the same as FIG. 3B illustrating the availability status of the individual at “8:00 AM”, for example. FIG. 4B illustrates the physical device 212 fifty-five minutes later at “8:55 AM” in which the portion 330 indicates that the next meeting occurs in five minutes, i.e., “Next meeting in five minutes in S170”. It will also be noticed in FIG. 4B that the visible physical device 212 displays a numerical percentage for a current availability status score 324 indicated as “11%” and an associated color indicator 326, e.g. the outline of the visible physical device 212 being lit in the associated brown color (or different color). Also in both FIGS. 4A and 4B a legend 340 is employed to identify the colors and a relative associated availability status associated with the different colors depending on their proximity to “Available” or “Not Available”.

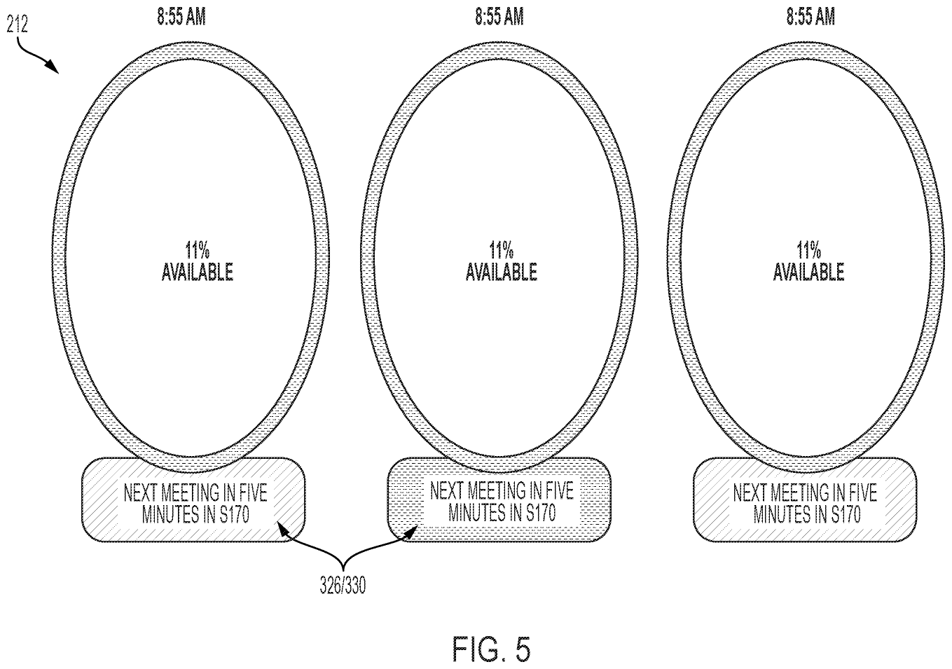

In another exemplary embodiment as illustrated in FIG. 5, the visible physical device 212 may flash to warn the individual, as well to alert others that someone's availability, i.e., the individual at the workspace, will soon be changing. In FIG. 5 for example, but not limited thereto, at “8:55 AM”, the associated color indicator 326 in the portion 330 may flash different colors to alert of an impending availability status change.

That is, having this physical, visual representation of an individual's availability at the desk or workspace of the individual not only alerts others in that physical space of the individual's availability, but also acts as a reminder to the individual as events are upcoming. These exemplary embodiments disclosed herein have an advantage over other solutions because the visible physical device 212 provides a readily visible physical representation of an individual's availability rather than yet another application downloaded onto each workstation in the open working environment. This makes a person's availability extremely clear in an open working environment. This invention has an advantage over other solutions in that it is not up to the user/individual to update his or her status as he or she is working. Rather, it is automatically updated based on the meetings he or she is in, as well as the work he or she is doing across her various devices.

The physical device 212 can also be used by the individual alone in the workspace to have notifications collected from multiple user devices 202-210 displayed in one place, and to use predicted availability scores to determine when they have commitments and for planning their day and week.

In exemplary embodiments, the current availability status score is automatically calculated based on a combination of machine learning and data analytics techniques that take a variety of variables into account. These variables include historical usage data for the individual from the network connected electronic devices used by the individual, communication data for the individual, calendar data for the individual and statutes set calendar data for the individual. More specifically, these variables can include, but are not limited to, an availability status that is provided by the individual, a historical usage pattern of the networked electronic devices and associated applications thereon used by the individual, an activity of the individual on the networked devices used by the individual (i.e., a keyboard or mouse activity on a computer, or a movement of a smartphone, tablet, smartwatch, etc.), including number, type and activity level of open applications. That is, the collected historical usage data includes the number, type and activity level of open applications on the network-connected devices the individual chooses to include, and how actively they are being used, a recent message response time of the individual, a last detected type of device on which the individual used, etc.

In exemplary embodiments, the communication data includes, but is not limited to, communication activity, such as voice conversations, instant/text messaging, and video conferencing on the network-connected devices used and selected by the individual. These devices include, but are not limited to, the user devices 202-210 illustrated in FIG. 2.

In exemplary embodiments, the calendar data includes, but is not limited to, schedule information, contained in calendar or scheduling applications, and extracted availability time from a calendar application from the network-connected devices used and selected by the individual.

In exemplary embodiments, the statutes set data includes, but is not limited to, statuses set in other communication programs, alarms, biometric data, etc., from the network-connected devices used and selected by the individual. Again, these devices include, but are not limited to, the user devices 202-210 illustrated in FIG. 2. For example, the biometric data may include the individual's heart rate obtained from the smartwatch 210. An above average heart rate might indicate above average stress and the individual is may be busier than normal and perhaps should not be interrupted. Another example of biometric data might include sensing eye movement of the individual by one of the user devices 202-210. For example, rapid eye movement may indicate that the user is busy, whereas as slow or no movement of the eyes may indicate that the individual is not busy, or nearly sleeping at his or her workspace.

It will be recognized by those skilled in the art that the actual data collection and analysis would be performed by software running on the selected user device 202—itself or one of the other network-connected devices 204-210.

In exemplary embodiments, the availability status scores are calculated using machine learning and predictive analytics techniques based upon the previous usage and data collected from the user selected networked connected electronic devices used by the individual. The previous usage of the user selected networked connected electronic devices involves the analysis of multiple individual state variables along with the corresponding user responsiveness to incoming conversation requests to the user selected networked connected electronic devices. The individual state variables include, but are not limited to, a manually set discrete user availability status, a date and time, a day of the week, a user keyboard and mouse activity, currently open applications and current application with focus, extracted availability time from calendar meetings, and message response time. In exemplary embodiments, the machine learning and predictive analytics techniques can be primed with logical baseline correlations, such as a development environment being the currently focused application contributing significantly to unavailability. The predicted future availability status score can be calculated using the same model for generating current availability status scores.

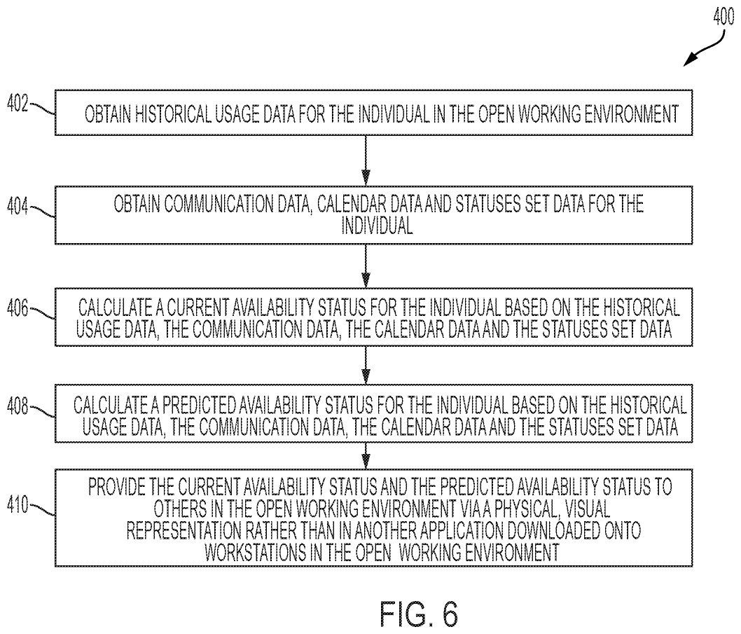

Referring now to FIG. 6, a method 400 for determining and providing an availability status of an individual in an open working environment is shown. As shown at block 402, the method 400 includes obtaining historical usage data for the individual in the open working environment. The method 400 also includes obtaining communication data, calendar data and statuses set data for the individual, as shown at block 404. In exemplary embodiments, the historical usage data can include the activity of the individual on the device that the individual is using and/or the application being used by the individual. In sum, the data collected from the selected network-connected user devices 202-210 used by the individual includes number, type and activity level of open applications; communication activity; schedule/calendar information; and statuses set in applications among the selected network-connected user devices 202-210. Next, as shown at block 406, the method 400 includes calculating a current availability status of the individual based on the historical usage data, the communication data, the calendar data and the statuses set data. In exemplary embodiments, the current availability status is calculated using machine learning and data analytic techniques that apply weighting factors to the various types of input data received. In exemplary embodiments, the current availability status score is a numerical value that is greater than or equal to zero and less than or equal to ten and the availability status scores consists of one decimal place.

The method 400 also includes calculating a predicted future availability status for the individual based on the historical usage data, the communication data, the calendar data and the statuses set data, as shown at block 408. The predicted future availability status includes predicted future availability status scores for each hour remaining in a current day. In exemplary embodiments, the predicted future availability status scores are numerical values that are greater than or equal to a minimum number, for example zero, and less than or equal to a maximum number, for example ten, and the availability status scores consists of one decimal place.

Next, as shown at block 410, the method 400 includes providing the current availability status and the predicted future availability status to others in the open working environment via a physical, visual representation on a network-connected device 212 rather than in another application downloaded onto workstations in the open working environment. In exemplary embodiments, the current availability status of the individual is provided using a graphical user interface that includes a color indicator that has a pigment determined based on the current availability status score. In exemplary embodiments, the predicted future availability status of the individual is provided using a graphical user interface that includes color indicators for each hour remaining in the current day where a pigment of the color indicators is determined based on the predicted future availability status scores.

In exemplary embodiments, the methods for calculating and visualizing an availability of a user in a messaging system provides multiple technical benefits. First, the current and predicted future availability status scores are automatically set and do not require input from the user. Next, the reliability of an availability status is improved because it is based on a broad set of inputs that are continuously monitored and the availability status is automatically and continuously updated. In addition, as shown in FIGS. 3A, 3B, 4A, 4B and 5, the availability status of an individual displayed on a physical device 212 proximate the individual's workspace provides multiple technical benefits. First, the current and predictive availability information can be easily visualized and it can be customized for an open working environment without others in the open working environment having to download another software application to gain the benefits. That is, actual data collection and analysis would be performed by software running on a single device or one of the other networked devices used by the individual. No other software application is necessary for others to be alerted of availability of individual. Second, having this physical, visual representation of your availability on your desk or workspace not only alerts others in that physical space of your availability, but also acts as a reminder to you as events are upcoming. Third, an advantage over other solutions for the disclosed problem is that it is not up to the individual to update his or her status as he or she is working. Rather, it is automatically updated based on the meetings the individual is in, as well as the work the individual is doing across the individual's various devices and then automatically providing a physical visual representation of the individual's availability to others in view of the individual's workspace.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for determining and providing an availability status of an individual in an open working environment, the method comprising:
obtaining historical usage data for the individual from selected network-connected devices used by the individual in the open working environment;
obtaining communication data, calendar data and statuses set data for the individual from the selected network-connected devices;
calculating, by a processor, a current availability status for the individual based on one or more of the historical usage data, the communication data, the calendar data and the statuses set data;
calculating, by the processor, a predicted future availability status for the individual based one or more of on the historical usage data, the communication data, the calendar data and the statuses set data; and
visibly displaying on a physical network-connected device proximate a workspace of the individual the current availability status and the predicted future availability status to others in the open working environment.

2. The method of claim 1, wherein the predicted future availability status includes predicted future availability status scores for each hour remaining in a current day.

3. The method of claim 2, wherein the predicted future availability status scores are numerical values that are greater than or equal to a minimum number and less than or equal to a maximum number and wherein the predicted future availability status scores consists of one decimal place.

4. The method of claim 3, wherein the predicted future availability status of the individual is provided using a graphical user interface that includes color indicators for each hour remaining in the current day where a pigment of the color indicators is determined based on the predicted future availability status scores.

5. The method of claim 1, wherein the current availability status includes a current availability status score.

6. The method of claim 5, wherein the current availability status score is a numerical value that that is greater than or equal to a minimum number and less than or equal to a maximum number and wherein the current availability status score consists of one decimal place.

7. The method of claim 5, wherein the current availability status of the individual is provided using a graphical user interface that includes a color indicator that has a pigment determined based on the current availability status score.

8. A computer program product for determining and providing an availability status of an individual in an open working environment, the computer program product comprising:
a non-transitory storage medium readable by a processing circuit and storing instructions for execution by the processing circuit for performing a method comprising:
obtaining historical usage data for the individual from selected network-connected devices used by the individual in the open working environment;
obtaining communication data, calendar data and statuses set data for the individual from the selected network-connected devices;
calculating a current availability status for the individual based on one or more of the historical usage data, the communication data, the calendar data and the statuses set data;
calculating a predicted future availability status for the individual based on one or more of the historical usage data, the communication data, the calendar data and the statuses set data; and
visibly displaying on a physical network-connected device proximate a workspace of the individual the current availability status and the predicted future availability status to others in the open working environment.

9. The computer program product of claim 8, wherein the predicted future availability status includes predicted future availability status scores for each hour remaining in a current day.

10. The computer program product of claim 9, wherein the predicted future availability status scores are numerical values that are greater than or equal to a minimum number and less than or equal to a maximum number and wherein the availability status scores consists of one decimal place.

11. The computer program product of claim 10, wherein the predicted future availability status of the individual is provided using a graphical user interface that includes color indicators for each hour remaining in the current day where a pigment of the color indicators is determined based on the predicted future availability status scores.

12. The computer program product of claim 8, wherein the current availability status includes a current availability status score.

13. The computer program product of claim 12, wherein the current availability status score is a numerical value that is greater than or equal to a minimum number and less than or equal to a maximum number and wherein the current availability status score consists of one decimal place.

14. The computer program product of claim 12, wherein the current availability status of the individual is provided using a graphical user interface that includes a color indicator that has a pigment determined based on the current availability status score.

15. A processing system for determining and providing an availability status of an individual in an open working environment includes a processor configured to control a content displayed on a display screen, the processor configured to:
obtain historical usage data for the individual from selected network-connected devices used by the individual in the open working environment;
obtain communication data, calendar data and statuses set data for the individual from the selected network-connected devices;
calculate a current availability status for the individual based on one or more of the historical usage data, the communication data, the calendar data and the statuses set data;
calculate a predicted future availability status for the individual based on one or more of the historical usage data, the communication data, the calendar data and the statuses set data; and
visibly displaying on a physical network-connected device proximate a workspace of the individual the current availability status and the predicted future availability status to others in the open working environment.

16. The processing system of claim 15, wherein the predicted future availability status includes predicted future availability status scores for each hour remaining in a current day.

17. The processing system of claim 16, wherein the predicted future availability status scores are numerical values that are greater than or equal to a minimum number and less than or equal to a maximum number and wherein the predicted future availability status scores consists of one decimal place.

18. The processing system of claim 17, wherein the predicted future availability status of the individual is provided using a graphical user interface that includes color indicators for each hour remaining in the current day where a pigment of the color indicators is determined based on the predicted future availability status scores.

19. The processing system of claim 15, wherein the current availability status includes a current availability status score.

20. The processing system of claim 19, wherein the current availability status score is a numerical value that is greater than or equal to a minimum number and less than or equal to a maximum number and wherein the current availability status score consists of one decimal place.
